(19) United States
(12) Patent Application Publication
(10) Pub. No.: US 2023/0158573 A1
(43) Pub. Date: May 25, 2023

(54) METAL DROP EJECTING THREE-DIMENSIONAL (3D) OBJECT PRINTER HAVING AN IMPROVED HEATED BUILD PLATFORM

(71) Applicant: Xerox Corporation, Norwalk, CT (US)

(72) Inventors: Glenn E. Batchelor, Fairport, NY (US); Ali R. Dergham, Fairport, NY (US); Timothy P. Foley, Marion, NY (US)

(21) Appl. No.: 17/455,785

(22) Filed: Nov. 19, 2021

(51) Int. Cl. B22F 12/17

(52) U.S. Cl. CPC B22F 12/17; B33Y 30/00

(57) ABSTRACT

A three-dimensional (3D) metal object manufacturing apparatus has a build platform heater that is configured with a plurality of temperature sensors and heating elements distributed throughout the heater. The signals generated by the temperature sensors are monitored by a controller and when one of the signals is outside of a temperature range around a temperature setpoint for the heater, the controller adjusts a PWM signal operating a switch that connects the heating element corresponding to the temperature sensor that generated the signal outside of the temperature range. The temperature sensors and heating elements are distributed in a plurality of cells that border one another in a contiguous pattern.

### TECHNICAL FIELD

This disclosure is directed to melted metal ejectors used in three-dimensional (3D) object printers and, more particularly, to the heating of the build platforms used in those systems.

### BACKGROUND

Three-dimensional printing, also known as additive manufacturing, is a process of making a three-dimensional solid object from a digital model of virtually any shape. Many three-dimensional printing technologies use an additive process in which an additive manufacturing device forms successive layers of the part on top of previously deposited layers. Some of these technologies use ejectors that eject UV-curable materials, such as photopolymers or elastomers. The printer typically operates one or more extruders to form successive layers of the plastic material that form a three-dimensional printed object with a variety of shapes and structures. After each layer of the three-dimensional printed object is formed, the plastic material is UV cured and hardens to bond the layer to an underlying layer of the three-dimensional printed object. This additive manufacturing method is distinguishable from traditional object-forming techniques, which mostly rely on the removal of material from a work piece by a subtractive process, such as cutting or drilling.

Recently, some 3D object printers have been developed that eject drops of melted metal through one or more nozzles to form 3D objects. These printers have a source of solid metal, such as a roll of wire or pellets, that is fed into a chamber of an ejector head where an external heater is operated to melt the solid metal. The ejector head is positioned within the opening of an electrical coil. An electrical current is passed through the coil to produce an electromagnetic field that causes the meniscus of the melted metal at a nozzle of the chamber to separate from the melted metal within the chamber and be propelled from the one or more nozzles. This type of metal drop ejecting printer is called a magnetohydrodynamic (MHD) printer by some in the art.

A platform is positioned opposite the nozzle(s) of the ejector and the ejector head is moved in a X-Y plane parallel to the plane of the platform by a controller operating actuators so the melted metal drops ejected from the nozzle form metal layers of an object on the platform. Another actuator is operated by the controller to alter the position of the ejector head or platform in the vertical or Z direction to position the ejector head and an uppermost layer of the metal object being formed by a distance appropriate for continuation of the object formation.

One type of MHD printer builds parts with drops exiting the nozzle at ˜400 Hz. The bulk metals melted for ejection from the nozzle of this printer include Al 6061, 356, 7075 and 4043. The size of the ejected drops is ˜0.5 mm in diameter and these drops spread to a size of ˜0.7 mm in diameter upon contact with the part surface. The melting temperature of these aluminum alloys is approximately 600° C. Empirical studies have shown that the optimal receiving surface temperature needs to be from ˜400° C. to ˜550° C. for good adherence to the previously formed surface. At these temperatures the melted metal drops combine with the build part in a uniform way that results in a strong and consistent build structure.

Heater plates that heat a build platform come in a variety of configurations. Many of these have one or more heating elements that wind in the plane of the heater plate in a serpentine manner, a back and forth pattern, or a maze configuration. A problem that arises from these known heater plates is irregular heating of the build platform. Portions of the platform that are directly adjacent a heating element reach temperatures that are hotter than portions not directly adjacent a heating element. This non-uniform distribution of heat across the build platform hinders the drops from combining smoothly or from bonding to one another as strongly as they should. This lackluster bonding increases porosity in the part, forms uneven build surfaces, produces unwelded drops, and yields shape inconsistencies. All of these unwanted results lead to degraded physical properties, such as low fatigue strength and tensile strength, as well as poor appearance issues in the final part. Being able to maintain a uniform distribution of heat across the build platform within an appropriate temperature range would be beneficial.

### SUMMARY

A new heater for a build platform in a 3D metal object printer more uniformly distributes heat across the build platform in a temperature range that enables strong melted metal drop bonding and object layer formation. The heater includes a plurality of sections that are positioned with respect to one another to form a structure encompassed by a single perimeter, and each section including at least one independently controllable heating element and at least one temperature sensor.

A new 3D metal object printer includes a heater for the build platform that more uniformly distributes heat across the build platform in a temperature range that enables strong melted metal drop bonding and object layer formation. The 3D metal object printer includes an ejector head configured to eject drops of melted metal, a planar member positioned to receive the ejected drops of melted metal, a plurality of sections that are positioned with respect to one another to form a structure encompassed by a single perimeter, the plurality of sections supporting the planar member, and each section in the plurality of sections including at least one independently controllable heating element and at least one temperature sensor.

### BRIEF DESCRIPTION OF THE DRAWINGS

The foregoing aspects and other features of a build platform heater in a 3D metal object printer that uniformly distributes heat across the build platform in the printer in a temperature range that enables strong melted metal drop bonding and object layer formation are explained in the following description, taken in connection with the accompanying drawings.

FIG. 1A is a top view of a build platform heater and build platform configuration that more uniformly distributes heat across the build platform.

FIG. 1B is a top view of the grid configuration of the build platform heater of FIG. 1A.

FIG. 1C is an expanded view of a corner of the grid configuration depicted in FIG. 1B.

FIG. 2A is a cross-sectional view of the build platform heater taken along lines 2A-2A in FIG. 1B.

FIG. 2B is a top view of a single cell of the build platform heater shown in FIG. 1B.

FIG. 2C is a cross-sectional view of the cell shown in FIG. 2B taken along lines 2C-2C.

FIG. 3A depicts an exemplary heater element for the single cell shown in FIG. FIG. 2B.

FIG. 3B depicts an exemplary thermocouple that can be used for temperature regulation of the single cell shown in FIG. 2B.

FIG. 3C depicts an exemplary thermistor that can be used for temperature regulation of the single cell shown in FIG. 2B.

FIG. 4 is a flow diagram of a process for operating the build platform heater of FIG. 1B.

FIG. 5A and FIG. 5B depict alternative embodiments of the build platform heater.

FIG. 6 depicts a previously known 3D metal object printer that has a build platform heater that cannot uniformly distributes heat across the build platform.

### DETAILED DESCRIPTION

For a general understanding of the environment for the build platform heater used in a 3D metal object printer and its operation as disclosed herein as well as the details for the build platform heater and its operation, reference is made to the drawings. In the drawings, like reference numerals designate like elements.

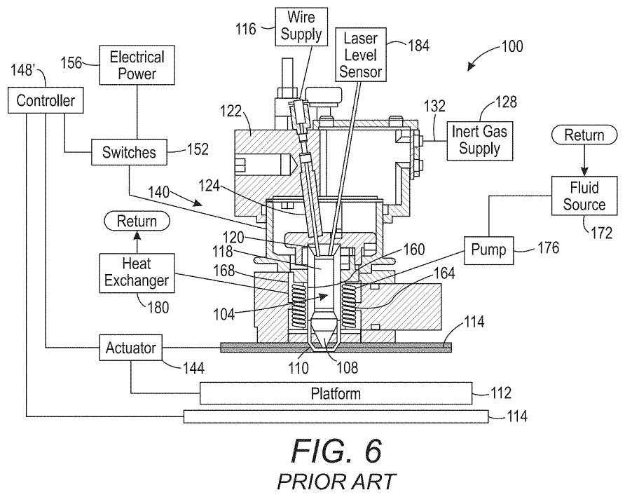

FIG. 6 illustrates an embodiment of a prior art melted metal 3D object printer 100 that uses a build platform heater 114 having one or more heating elements that are unable to heat the platform 112 uniformly. The platform 112 is a solid metal plate. The heating elements of the heater 114 are operatively connected to the controller 148 for operation of the heating elements. In the printer of FIG. 6, drops of melted bulk metal are ejected from a receptacle of a removable vessel 104 having a single nozzle 108 and drops from the nozzle form swaths for layers of an object on a platform 112. As used in this document, the term “removable vessel” means a hollow container having a receptacle configured to hold a liquid or solid substance and the container as a whole is configured for installation and removal in a 3D metal object printer. As used in this document, the term “bulk metal” means conductive metal available in aggregate form, such as wire of a commonly available gauge or pellets of macro-sized proportions. A source of bulk metal 116, such as metal wire 120, is fed into a wire guide 124 that extends through the upper housing 122 in the ejector head 140 and melted in the receptacle of the removable vessel 104 to provide melted metal for ejection from the nozzle 108 through an orifice 110 in a baseplate 114 of the ejector head 140. As used in this document, the term “nozzle” means an orifice in a removable vessel configured for the expulsion of melted metal drops from the receptacle within the removable vessel. As used in this document, the term “ejector head” means the housing and components of a 3D metal object printer that melt, eject, and regulate the ejection of melted metal drops for the production of metal objects.

With continued reference to FIG. 6, a melted metal level sensor 184 includes a light source and a reflective sensor. In one embodiment, the light source is a laser and, in some embodiments, a blue laser. The reflection of the laser off the melted metal level is detected by the reflective sensor, which generates a signal indicative of the distance to the melted metal level. The controller receives this signal and determines the level of the volume of melted metal in the removable vessel 104 so it can be maintained at the upper level 118 in the receptacle of the removable vessel. The removable vessel 104 slides into the heater 160 so the inside diameter of the heater contacts the removable vessel and can heat solid metal within the receptacle of the removable vessel to a temperature sufficient to melt the solid metal. As used in this document, the term “solid metal” means a metal as defined by the periodic chart of elements or alloys formed with these metals in solid rather than liquid or gaseous form. The heater is separated from the removable vessel to form a volume between the heater and the removable vessel 104.

Continuing with the discussion of the printer shown in FIG. 6, an inert gas supply 128 provides a pressure regulated source of an inert gas, such as argon, to the ejector head through a gas supply tube 132. The gas flows through the volume between the heater and the removable vessel and exits the ejector head around the nozzle 108 and the orifice 110 in the baseplate 114. This flow of inert gas proximate to the nozzle insulates the ejected drops of melted metal from the ambient air at the baseplate 114 to prevent the formation of metal oxide during the flight of the ejected drops.

The ejector head 140 of FIG. 6 is movably mounted within Z-axis tracks for vertical movement of the ejector head with respect to the platform 112. One or more actuators 144 are operatively connected to the ejector head 140 to move the ejector head along a Z-axis while other actuators 144 are operatively connected to the platform 112 to move the platform in an X-Y plane beneath the ejector head 140. The actuators 144 are operated by a controller 148 to maintain an appropriate distance between the orifice 110 in the baseplate 114 of the ejector head 140 and an uppermost surface of an object on the platform 112.

Moving the platform 112 of FIG. 6 in the X-Y plane as drops of molten metal are ejected toward the platform 112 forms a swath of melted metal drops on the object being formed. Controller 148 also operates actuators 144 to adjust the vertical distance between the ejector head 140 and the most recently formed layer on the substrate to facilitate formation of other structures on the object. While the molten metal 3D object printer 100 is depicted in FIG. 6 as being operated in a vertical orientation, other alternative orientations can be employed. Also, while the embodiment shown in FIG. 6 has a platform that moves in an X-Y plane and the ejector head moves along the Z axis, other arrangements are possible. For example, the actuators 144 can be configured to move the ejector head 140 in the X-Y plane and along the Z axis or they can be configured to move the platform 112 in both the X-Y plane and Z-axis.

The controller 148 operates the switches 152 selectively. One switch 152 can be selectively operated by the controller to provide electrical power from source 156 to the heater 160, while another switch 152 can be selectively operated by the controller to provide electrical power from another electrical source 156 to the coil 164 for generation of the electrical field that ejects a drop from the nozzle 108. Because the heater 160 generates a great deal of heat at high temperatures, the coil 164 is positioned within a chamber 168 formed by one (circular) or more walls (rectilinear shapes) of the ejector head 140. As used in this document, the term “chamber” means a volume contained within one or more walls in which a heater, a coil, and a removable vessel of a 3D metal object printer are located. The removable vessel 104 and the heater 160 are located within this chamber. The chamber is fluidically connected to a fluid source 172 through a pump 176 and also fluidically connected to a heat exchanger 180. As used in this document, the term “fluid source” refers to a container of a liquid having properties useful for absorbing heat. The heat exchanger 180 is connected through a return to the fluid source 172. Fluid from the source 172 flows through the chamber to absorb heat from the coil 164 and the fluid carries the absorbed heat through the exchanger 180, where the heat is removed by known methods. The cooled fluid is returned to the fluid source 172 for further use in maintaining the temperature of the coil in an appropriate operational range.

The controller 148 of the 3D metal object printer 100 requires data from external sources to control the printer for metal object manufacture. In general, a three-dimensional model or other digital data model of the object to be formed is stored in a memory operatively connected to the controller 148, the controller can access through a server or the like a remote database in which the digital data model is stored, or a computer-readable medium in which the digital data model is stored can be selectively coupled to the controller 148 for access. This three-dimensional model or other digital data model is processed by a slicer implemented with the controller to generate machine-ready instructions for execution by the controller 148 in a known manner to operate the components of the printer 100 and form the metal object corresponding to the model. The generation of the machine-ready instructions can include the production of intermediate models, such as when a CAD model of the device is converted into an STL data model, or other polygonal mesh or other intermediate representation, which can in turn be processed to generate machine instructions, such as g-code, for fabrication of the device by the printer. As used in this document, the term “machine-ready instructions” means computer language commands that are executed by a computer, microprocessor, or controller to operate components of a 3D metal object additive manufacturing system to form metal objects on the platform 112. The controller 148 executes the machine-ready instructions to control the ejection of the melted metal drops from the nozzle 108, the positioning of the platform 112, as well as maintaining the distance between the orifice 110 and the uppermost layer of the object on the platform 112.

The controller 148 can be implemented with one or more general or specialized programmable processors that execute programmed instructions. The instructions and data required to perform the programmed functions can be stored in memory associated with the processors or controllers. The processors, their memories, and interface circuitry configure the controllers to perform the operations previously described as well as those described below. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits. During metal object formation, image data for a structure to be produced are sent to the processor or processors for controller 148 from either a scanning system or an online or work station connection for processing and generation of the signals that operate the components of the printer 100 to form an object on the platform 112.

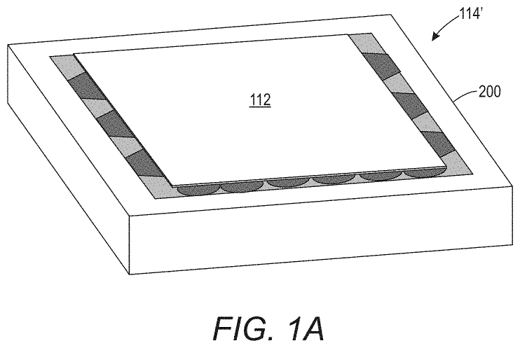

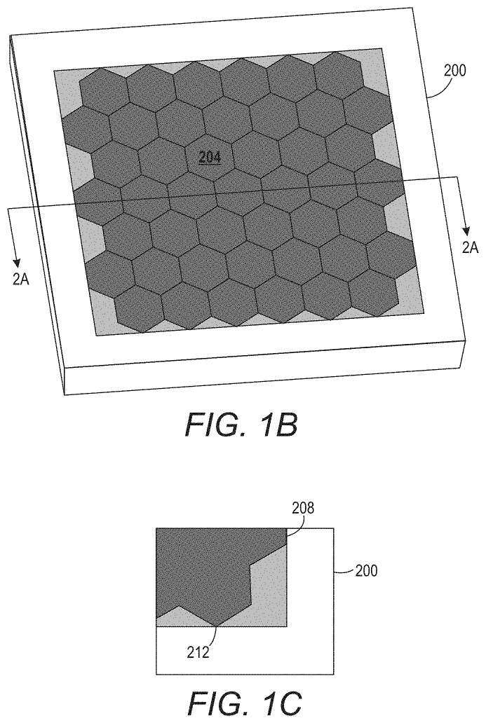

Using like reference numbers for like components, a new build platform heater 114' and platform 112 configuration is shown in FIG. 1A. This configuration can be installed in the 3D metal object printer 100 shown in FIG. 6 to improve the distribution of heat across the platform 112. As shown in FIG. 1A, the platform is positioned on the upper surface of the heater 114'. As shown in FIG. 1B, the build platform heater 114' includes a frame 200, which is made of an electrical non-conductive material, and a grid of hexagonal cells 204. The hexagonal shape of the cells provides good thermal contact with the adjacent cells. Additionally, the hexagonal shape of the cells helps maintain structural integrity of the heater, even when the grid is made of lighter materials. The width and length of the grid 204 is the same as the internal dimensions of the frame 200. Also, the height of the grid 204 is the same as the height of the frame 200 so the grid supports itself within the frame 200. The flat portions of the cells exposed on opposite sides of the grip can be connected to the frame 200 with adhesive as also are the points of the cells exposed on the other two opposite sides of the grid 204. As used in this document, the term “cell” means a volume of material enclosed by a continuous polygonal perimeter. A corner of the grid 204 showing both types of connections 208 and 212 between the grid and the frame is shown in FIG. 1C.

The cells are made of materials that have a high coefficient of thermal conductivity, such as molybdenum steel or other steel alloys provided the alloy withstands temperatures greater than 500° C. well. The material is divided into solid blocks and machined into a polygonal shape that can adjoin to the perimeters of adjacent cells. These shapes include, but are not limited to, hexagons, squares, rectangles, triangles, and the like. A channel for the heating element is drilled in the center of the cell and another channel is drilled offset from the center for the temperature sensor. The width of a cell corresponds to the heat output of the heating element. That is, the cell is sized so the portions of the cell further from the heating element reach an adequate temperature for supplying heat to the build platform without requiring the heating element to be driven by a 100% duty cycle signal continuously. The height of the cells can vary depending upon the location of the cell in the grid. For example, cells in the central portion of the grid can be more shallow since they receive heat from the adjacent cells surrounding them. Cells on the perimeter can have a greater height to maintain heat in the regions further from the build area, which is typically centralized on the build platform. A high temperature adhesive sealant capable of withstanding temperatures up to about 1260° C. is applied to the faces of the polygonal perimeter of the cells and the cells are joined together to form the grid and the frame is mounted about the grid.

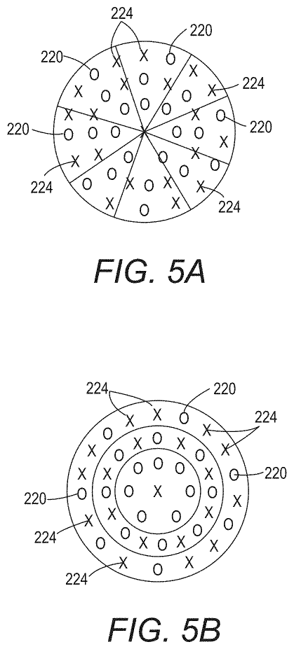

In alternative embodiments, heater sections are cast of the thermal conductive material so that they are combined to form a heater configured to support a build platform. As used in this document, the term “section” means a volume of material that can be positioned adjacent to another volume of material to form a contiguous grid. As used in this document, the term “grid” means a plurality of sections that can be positioned adjacent to one another to form a structure encompassed by a single perimeter. For example, pie slice sectors, sections conforming to parts of a commonly manufactured part, or concentric rings can be formed. In these sections, which are larger than the cells discussed above, the heating elements and temperature sensors are distributed in the sections so that the temperature sensors can generate signals indicative of the temperatures in every portion of the sections. For example, as shown in FIG. 5A, heating elements 220 and temperature sensors 224 are distributed in each pie slice portion 504 so signals indicative of the temperatures throughout the slice are generated and these signals are used as discussed below to operate the heating elements closest to the temperature sensors. FIG. 5B depicts an embodiment in which concentric rings 508 having temperature sensors 224 and heating elements 220 form the heater 114'.

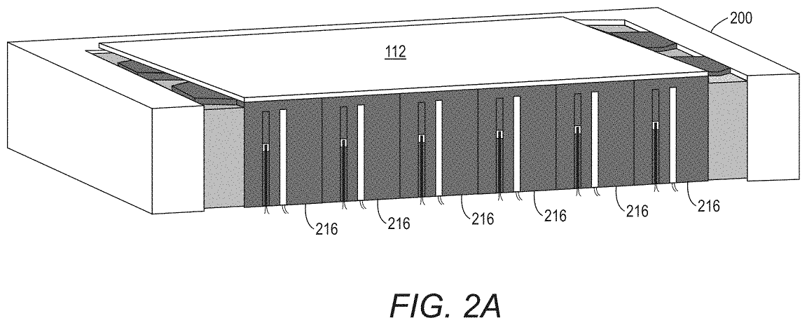

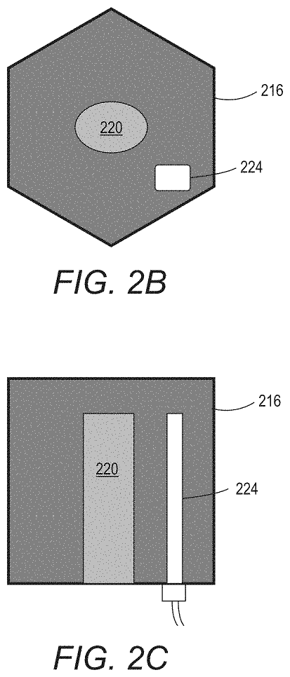

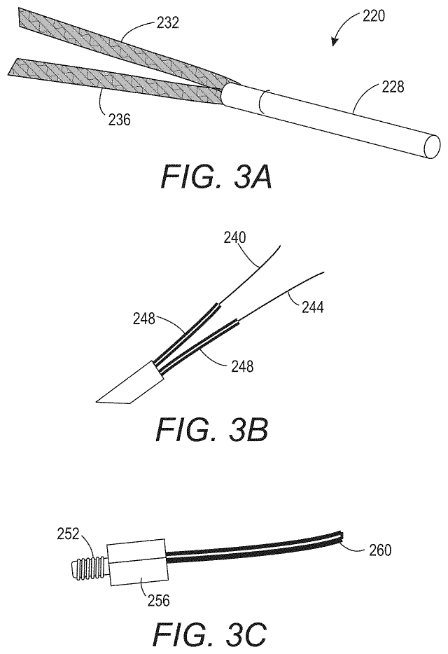

FIG. 2A is a cross-sectional view of the hexagonal grid of FIG. 1B taken along lines 2A. Each of the cells 216 in a row of the grid has a pair of elongated openings, one of which is positioned in the center of the cell. A heating element 220 is placed in this centered opening. As used in this document, the term “heating element” means a device that generates heat when a voltage is dropped across the device or a current is conducted through the device. As shown in FIG. 3A, the heating element 220 includes a cap 228 from which a pair of electrical wires 232 and 236 extend for connection to a power supply, such as power supply 156 (FIG. 5). The controller 148 is operatively connected to one of the electrical switches 152 to connect the power supply 156 to one of the heating elements 220 installed in one of the cells 216 to regulate the temperature of the cell in a manner described more fully below.

In the non-centered opening of the cell 216 shown in FIG. 2A, a temperature sensor 224, such as a thermocouple or a thermistor, is positioned. The temperature sensor 224 is operatively connected to the controller 148 to provide a signal indicative of the temperature of the cell 216. As shown in FIG. 3B, a thermocouple having two wires 240 and 244 made of dissimilar metals are exposed by removing their insulation 248 and electrically connected to each other. The other ends of each wire are electrically connected to copper wires so they can be connected to a component that is configured to measure the voltage at the junction between the two dissimilar metals. This voltage corresponds to the temperature at the junction. In one known thermocouple, the positive lead of the thermocouple is Nickel-Chromium and the negative lead is Nickel-Aluminum and the thermocouple has a range of about −200° C. to about 1250° C. As shown in FIG. 3C, a thermistor is depicted. The thermistor includes a threaded probe 252, a hex nut 256, and a pair of electrical leads 260. Within the probe is a material that changes its electrical resistance as the temperature of the material changes. The probe is screwed into the off-centered opening in a cell 216 and the electrical leads 260 are connected to an electrical power supply that supplies an electrical voltage across the material. The voltage drop across the material is measured and as the temperature of the material changes the voltage drop indicates the temperature of the probe inside the cell opening. In one embodiment, a negative temperature coefficient (NTC) thermistor is used, although positive temperature coefficient (PTC) thermistors can be used as well. Thus, the thermocouples or thermistors provide signals indicative of the temperatures of the cell material in which it is installed. In the build platform heater shown in the figures, the temperature sensors, heating elements, and switches are provided in a one-to-one correspondence with regard to one another, although the number of temperature sensors and heating elements need not be the same.

The controller monitors the temperature sensors, that is, the thermocouples or thermistors, for each cell and generates a pulse width modulated (PWM) signal for operating the digital switch that connects the heating element to electrical power. Each switch, and therefore each heating element, is controlled independently of the other switches to regulate the temperature of the heater 114'. The signal from each temperature sensor is monitored and compared to a range set about the temperature setpoint for the heater grid. The temperature setpoint can be provided through an user interface operatively connected to the controller but a default temperature setpoint can be stored in a memory operatively connected to the controller. The temperature range need not be centered about the setpoint but the setpoint needs to be within the temperature range. If the temperature indicated by the signal exceeds the upper end of the range, then the duty cycle of the PWM signal for the switch connecting the heating element to electrical power is reduced. If the temperature indicated by the signal is below the lower end of the range, then the duty cycle of the PWM signal for the switch connecting the heating element to electrical power is increased. In one embodiment, the grid temperature setpoint is 550° C. and the temperature range is approximately 545-555° C.

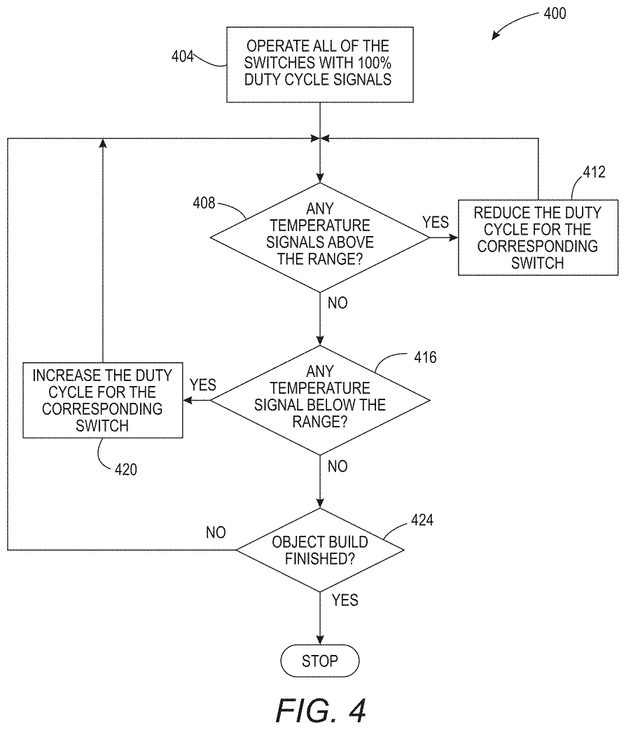

A process for operating the build platform heater in a printer is shown in FIG. 4. In the description of the process, statements that the process is performing some task or function refers to a controller or general purpose processor executing programmed instructions stored in non-transitory computer readable storage media operatively connected to the controller or processor to manipulate data or to operate one or more components in the printer to perform the task or function. The controller 148 noted above can be such a controller or processor. Alternatively, the controller can be implemented with more than one processor and associated circuitry and components, each of which is configured to form one or more tasks or functions described herein. Additionally, the steps of the method may be performed in any feasible chronological order, regardless of the order shown in the figures or the order in which the processing is described.

FIG. 4 is a flow diagram 400 of a process that operates the build platform heater 114′ in a printer. The process begins at printer start-up with all of the digital switches that connect the heating elements of the build platform heater to electrical power being operated with a 100% duty cycle signal (block 404). The signals from the temperature sensors for the cells are then monitored (block 408). When the temperature for any cell exceeds the upper end of the temperature range for operation of the heater, the duty cycle for that cell is reduced (block 412) and the process continues monitoring the temperature signals (block 408). If the temperature signal for a cell is less than the lower end of the temperature range (block 416), then the duty cycle for the switch connecting the heating element to electrical power is increased (block 420). Of course, if the duty cycle is at 100%, the duty cycle remains at 100%. The process continues until the build process is finished (block 424).

It will be appreciated that variants of the above-disclosed and other features and functions, or alternatives thereof, may be desirably combined into many other different systems, applications or methods. Various presently unforeseen or unanticipated alternatives, modifications, variations or improvements may be subsequently made by those skilled in the art that are also intended to be encompassed by the following claims.

What is claimed:

1. A heater for a platform assembly for supporting a workpiece in a three-dimensional (3D) printer comprising:
a plurality of sections that are positioned with respect to one another to form a structure encompassed by a single perimeter; and
each section including at least one independently controllable heating element and at least one temperature sensor.

2. The heater of claim 1 wherein each section has a substantially similar shape.

3. The heater of claim 1 wherein each section has substantially similar dimensions.

4. The heater of claim 2 wherein each section has a hexagonal shape.

5. The heater of claim 2 wherein each section has a ring shape.

6. The heater of claim 1 further comprising:
a member positioned over an upper surface of the structure formed by the plurality of sections.

7. The heater of claim 6 wherein the upper surface of the structure is essentially flat.

8. The heater of claim 6 wherein each section consists essentially of a thermal conductive material.

9. The heater of claim 8 wherein the thermal conductive material is a steel alloy.

10. The heater of claim 9 wherein the steel alloy is molybdenum steel.

11. The heater of claim 1 wherein the at least one temperature sensor is one of a thermocouple and a thermistor.

12. The heater of claim 11 further comprising:
a plurality of switches, each switch being connected to one of the at least one heating elements in the plurality of sections to connect the at least one heating element to an electrical power source selectively.

13. The heater of claim 12 further comprising:
a controller operatively connected to the plurality of switches, the controller being configured to:
operate each switch in the plurality of switches independently of the other switches.

14. The heater of claim 13, the controller being further configured to:
operate each switch with a pulse width modulated (PWM) signal that is independently generated for each switch.

15. The heater of claim 14, the controller being operatively connected to the at least one temperature sensor in each section in the plurality of sections and the controller being further configured to:
compare the signal from each temperature sensor to a temperature range about a temperature setpoint; and
change a duty cycle of the PWM signal operating the switch that corresponds to the at least one heating element in the section when the signal from the at least one temperature sensor in the section is outside of the temperature range.

16. The heater of claim 15, the controller being further configured to:
reduce the duty cycle of the PWM signal when the signal generated by the at least one temperature sensor in the section is below the temperature range.

17. The heater of claim 16, the controller being further configured to:
increase the duty cycle of the PWM signal when the signal generated by the at least one temperature sensor in the section is below the temperature range.

18. A three-dimensional (3D) metal object printer comprising:
an ejector head configured to eject drops of melted metal;
a planar member positioned to receive the ejected drops of melted metal;
a plurality of sections that are positioned with respect to one another to form a structure encompassed by a single perimeter, the plurality of sections supporting the planar member; and
each section in the plurality of sections including at least one independently controllable heating element and at least one temperature sensor.

19. The 3D metal object printer of claim 18 further comprising:
a plurality of switches, each switch being connected to one of the at least one heating elements in the plurality of sections to connect the at least one heating element to an electrical power source selectively; and
a controller operatively connected to the plurality of switches, the controller being configured to operate each switch in the plurality of switches independently of the other switches.

20. The 3D metal object printer of claim 19, the controller being further configured to:
operate each switch with a pulse width modulated (PWM) signal that is independently generated for each switch;
compare the signal from each temperature sensor to a temperature range about a temperature setpoint; and
change a duty cycle of the PWM signal operating the switch that corresponds to the at least one heating element in the section when the signal from the at least one temperature sensor in the section is outside of the temperature range.
